(19) United States
(12) Patent Application Publication
(10) Pub. No.: US 2026/0249533 A1
(43) Pub. Date: Aug. 27, 2026

(54) MOLDING SYSTEM HAVING A VISION SYSTEM AND A METHOD FOR OPTICALLY INSPECTING MOLDED ARTICLES

(71) Applicant: Husky Injection Molding Systems Ltd., Bolton (CA)

(72) Inventors: Dirk Holger Schlums, Mulmur (CA); Robert Bruce Weber, Brampton (CA)

(73) Assignee: Husky Injection Molding Systems Ltd., Bolton, ON (CA)

(21) Appl. No.: 18/877,217

(22) PCT Filed: Jul. 18, 2023
(86) PCT No.: PCT/CA2023/050964

§ 371 Date: Dec. 19, 2024

Related U.S. Application Data
(60) Provisional application No. 63/369,404, filed on Jul. 26, 2022.

(51) Int. Cl. B29C 45/76; B29K 105/00

(52) U.S. Cl. CPC B29C 45/76; B29C 2945/76153; B29C 2945/7629; B29C 2945/76464; B29C 2945/76809; B29C 2945/76832; B29C 2945/76943; B29K 2105/0032

(57) ABSTRACT

A molding system including a molding machine, a vision system and a processor is disclosed. The molding machine, which is for producing a plurality of molded articles, has a additive device for adjusting a color of the plurality of molded articles. The vision system is for detecting a color of each of at least two molded articles of the plurality of molded articles. The processor, which is operatively connected to the molding machine and to the vision system, is configured to analyze data generated by the vision system, and in response to a difference between (i) an average of a detected color of at least two molded articles and (ii) a desired color being different from a predetermined value, the processor is configured to control the additive device for adjusting the color of the plurality of molded articles. Methods for optically inspecting molded articles are also disclosed.

### FIELD OF THE TECHNOLOGY

The present technology relates to molding systems and methods for using the molding systems. More specifically the present technology relates to a molding system for producing and inspecting molded articles, and a method for inspecting molded articles during operation of the molding system.

### BACKGROUND

Molding is a process by virtue of which a molded article can be formed from molding material by using a molding system. Various molded articles can be formed by using the molding process, such as an injection molding process. One example of a molded article that can be formed, for example, from polyethylene terephthalate (PET) material is a preform that is capable of being subsequently blown into a beverage container, such as, a bottle and the like.

Broadly speaking, the cost of producing a molded article is made up of the capital cost of the molding system itself, the cost of resin, and other overheads (electricity, water supply, labour costs, etc.). In order to garner the most profitability from the system, the molding system should be running as much as possible, and at full capacity. To extend the life of the molding system, regular inspection is important. One manner of inspecting such a machine is inspecting the molded articles produced by the machine.

In order to minimize downtime, inspection should not impede operation of the molding system, and inspection of the molded articles should take place with a minimum of delay from when they are molded, to intercept issues as quickly as possible.

In some instances, where the molded articles are preforms, their colors may be offset from a desired color. Inspection by individually handling the molded articles can be both time-consuming and difficult.

### SUMMARY

It is an object of the present invention to ameliorate at least some of the inconveniences present in the prior art.

According to one broad aspect of the present technology, there is provided a molding system including a molding machine, a vision system, and a processor. The molding machine is for producing a plurality of molded articles, and has an additive device for adjusting a color of the plurality of molded articles. The vision system is for detecting a color of each of at least two molded articles of the plurality of molded articles. The processor, which is operatively connected to the molding machine and to the vision system, is configured to analyze data generated by the vision system, and in response to a difference between (i) an average of a detected color of at least two molded articles and (ii) a desired color being different from a predetermined value, the processor is configured to control the additive device for adjusting the color of the plurality of molded articles.

In some embodiments of the molding system, in order to adjust the color of the plurality of molded articles, the additive device is configured to add an additive into an injection unit of the molding machine.

In some embodiments of the molding system, the processor is configured to control the additive device according to a pre-calculated remedial model.

In some embodiments of the molding system, the pre-calculated remedial model is a first-order system.

In some embodiments of the molding system, the first-order system is a first order plus time delay.

In some embodiments of the molding system, the average of the detected color of the at least two molded articles is taken over a plurality of molding cycles.

In some embodiments of the molding system, a number of the plurality of molding cycles is determined based on a time response of the additive device.

In some embodiments of the molding system, a first of the at least two molded articles is taken from a first molding cycle of the plurality of molding cycles, and a second of the at least two molded articles is taken from a second molding cycle of the plurality of molding cycles.

In some embodiments of the molding system, a first of the at least two molded articles originates from a first molding cavity, and a second of the at least two molded articles originates from a second molding cavity.

In some embodiments of the molding system, the at least two molded articles originate from a same molding cavity.

In some embodiments of the molding system, at least two molded articles includes all of the plurality of molded articles, and the processor is configured to analyze the data generated by the vision system to determine workable data and unworkable data, and to calculate the average of the detected color from the workable data.

In some embodiments of the molding system, the detected color is communicated to the controller as a set of three or more color parameters.

In some embodiments of the molding system, the vision system includes a black box enclosure configured to receive the at least two molded articles, a light source for illuminating the at least two molded articles, and a detector configured to detect a color of the at least two molded articles.

In some embodiments of the molding system, the black box enclosure is adjustable between a receiving position, in which the black box enclosure is configured to receive a molded article, and a releasing position, in which the black box enclosure is configured to release the molded article.

In some embodiments of the molding system, the black box enclosure has moveable member moveable between a receiving position, in which the black box enclosure is configured to receive a molded article, and a releasing position, in which the black box enclosure is configured to release the molded article.

In some embodiments of the molding system, the additive device is a first additive device, and the molding machine further includes a second additive device, the first color being configured to dose a first additive, and the second additive device being configured to dose a second additive.

According to an alternative broad aspect of the present technology, there is provided a molding system including a molding machine, a vision system including a black box enclosure, a light source and a detector, as well as a processor. The molding machine is for producing a plurality of molded articles, and has an additive device for adjusting a color of the plurality of molded articles. The vision system is configured to inspect at least one molded article of the plurality of molded articles. The black box enclosure is configured to receive the at least one molded article, the light source is for illuminating the at least one molded article, and the detector is configured to detect a color of the at least one molded article. The processor, which is operatively connected to the molding machine and to the vision system, is configured to analyze data generated by the vision system, and in response to a detected color of the at least one molded article being different from a desired color, the processor controls the additive device for adjusting a color of the plurality of molded articles.

In some embodiments of the molding system, the black box enclosure is rotatable between a receiving position, in which the black box enclosure is configured to receive a molded article, and a release position, in which the black box enclosure is configured to release the molded article.

In some embodiments of the molding system, the black box enclosure has a moveable member moveable between a receiving position, in which the black box enclosure is configured to receive a molded article, and a release position, in which the black box enclosure is configured to release the molded article.

In some embodiments of the molding system, the black box enclosure is situated in the molding area. The vision system is configured to inspect at least one part within that enclosure to detect the color of that molded article while the molded article remains on the molding surface. The processor, which is operatively connected to the molding machine and to the vision system, is configured to analyze data generated by the vision system, and in response to a detected color of the at least one molded article being different from a desired color, the processor controls the additive device for adjusting a color of the plurality of molded articles.

In some embodiments of the molding system, in order to adjust the color of the plurality of molded articles, the additive device is configured to add an additive into an injection unit of the molding machine.

In some embodiments of the molding system, the processor is configured to control the additive device according to a pre-calculated remedial model.

In some embodiments of the molding system, the pre-calculated remedial model is a first-order system.

In some embodiments of the molding system, the first-order system is a first order plus time delay.

In some embodiments of the molding system, the processor is configured to take an average of the detected color of the at least one molded article over a plurality of molding cycles.

In some embodiments of the molding system, a number of the plurality of molding cycles is determined based on a time response of the additive device.

In some embodiments of the molding system, a first of the at least two molded articles is taken from a first molding cycle of the plurality of molding cycles, and a second of the at least two molded articles is taken from a second molding cycle of the plurality of molding cycles.

In some embodiments of the molding system, a first of the at least two molded articles originates from a first molding cavity, and a second of the at least two molded articles originates from a second molding cavity.

In some embodiments of the molding system, the at least two molded articles originate from a same molding cavity.

In some embodiments of the molding system, the detected color is communicated to the controller as a set of three color parameters.

In some embodiments of the molding system, the additive device is a first additive device, and the molding machine further includes a second additive device, the first color being configured to dose a first additive, and the second additive device being configured to dose a second additive.

According to another broad aspect of the present technology, there is provided a method for optically inspecting at least two molded articles. The method, which is executable by a processor of an injection molding machine, includes: causing the injection machine to mold a plurality of molded articles, causing detection, by a vision system, of a color of at least two molded articles of the plurality of molded articles; and comparing an average of a detected color of each of the at least two molded articles with a desired color. In response to a difference between the average of the detected color of each of the at least two molded articles and a desired color being different from a predetermined value, the processor controlling the additive device for adjusting a color of the plurality of molded articles.

In some embodiments of the method, the processor is configured to control the additive device according to a pre-calculated remedial model.

In some embodiments of the method, the method further includes running a testing cycle to determine parameters of the pre-calculated remedial model.

In some embodiments of the method, the method further includes causing detection over a plurality of molding cycles, and the average of the detected color of each of the at least two molded articles is determined over the plurality of molding cycles.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

These and other aspects and features of non-limiting embodiments of the present technology will now become apparent to those skilled in the art upon review of the following description of specific non-limiting embodiments of the technology in conjunction with the accompanying drawings.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

A better understanding of the embodiments of the present technology (including alternatives and/or variations thereof) may be obtained with reference to the detailed description of the non-limiting embodiments along with the following drawings, in which:

FIG. 1 is a cross-sectional view of a multilayer preform, which can be inspected by non-limiting embodiments of the present technology;

FIG. 2 is a schematic diagram of an injection system including an injection molding machine, a vision system, and a processor;

FIG. 3 is a schematic diagram of an injection system according to an alternative embodiment of the present technology, the injection system including an injection molding machine, a vision system, and a processor;

FIG. 4A is a schematic cross-sectional view of a vision system including a black box enclosure, a light source and a detector, the black box enclosure being in a receiving position and having a preform received therein;

FIG. 4B is a schematic cross-sectional view of the vision system of FIG. 4A, and the black box enclosure being in a releasing position;

FIG. 5A is a schematic cross-sectional view according to an alternative embodiment of a vision system, the vision system including a black box enclosure having a moveable member, a light source and a detector, the slideable member being in a receiving position, and the black box enclosure having a preform received therein;

FIG. 5B is a schematic cross-sectional view of the vision system of FIG. 5A, and the moveable member being in a releasing position;

FIG. 6 is a schematic diagram of an injection system according to an alternative embodiment of the present technology, the injection system including an injection molding machine, a vision system, and a processor; and

FIG. 7 depicts a block diagram of a method executable in accordance with non-limiting embodiments of the present technology.

### DETAILED DESCRIPTION

Reference will now be made in detail to various non-limiting embodiment(s) of a molding system and a related method for the operation thereof. It should be understood that other non-limiting embodiment(s), modifications and equivalents will be evident to one of ordinary skill in the art in view of the non-limiting embodiment(s) disclosed herein and that these variants should be considered to be within scope of the appended claims.

Furthermore, it will be recognized by one of ordinary skill in the art that certain structural and operational details of the non-limiting embodiment(s) discussed hereafter may be modified or omitted (i.e. non-essential) altogether. In other instances, well known methods, procedures, and components have not been described in detail.

There exists ways and means to check parameters of a molded article after it exits a molding system (i.e. downstream of the molding system), however this is after the fact, and it is time consuming. There may be large numbers of defective molded articles produced before the molding process can be adjusted.

Disclosed is a molding system configured to associate each preform to a corresponding molding cavity while handling the preforms as an aggregate, instead of individually manipulating the perform, such that complexity and costs of the molding system can be reduced.

Thus, if a defective preform is produced by a defective molding cavity, the defective molding cavity can be identified, and a controller can adjust one or more operational parameter thereof to limit the number of defective preforms produced, resulting in reduction of waste generation.

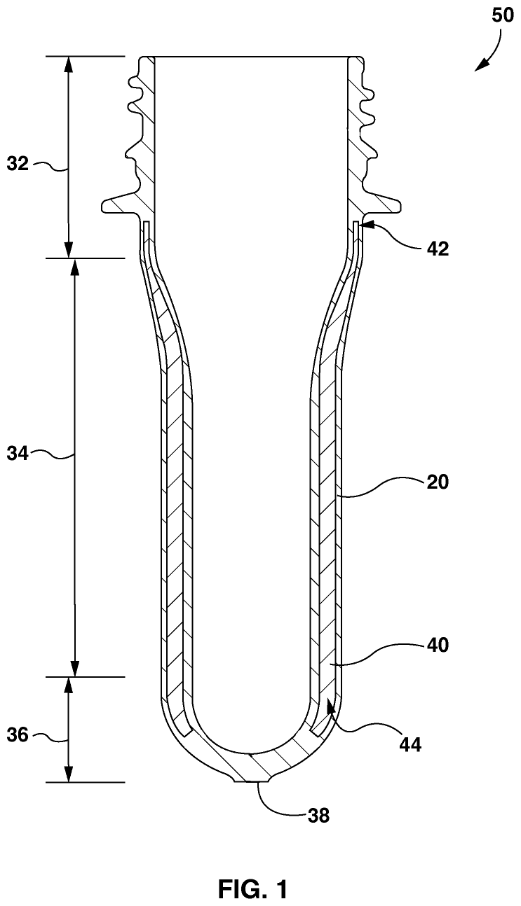

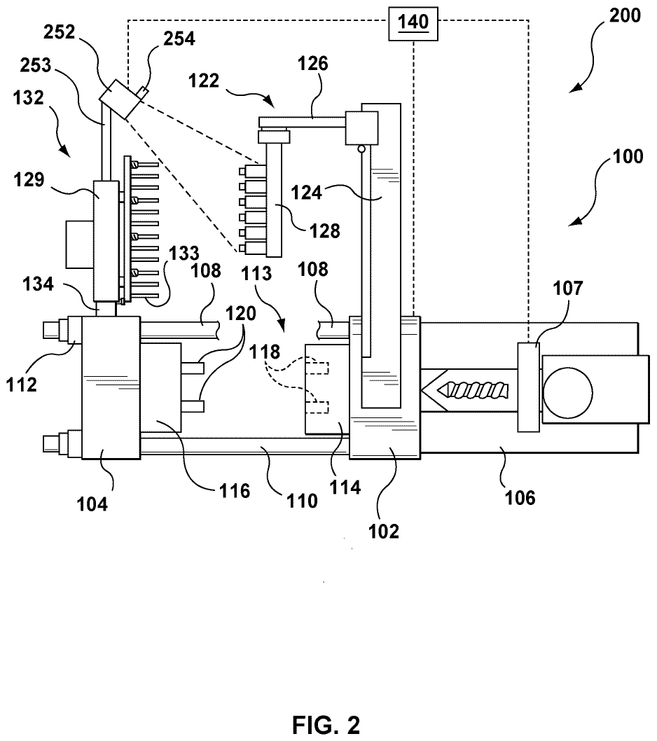

With reference to FIG. 1, there is depicted, in cross-section, a non-limiting embodiment of a molded article produced by a molding machine of the present technology, specifically a preform 50. The illustrated preform 50 is produced by an injection molding machine 100, described below with reference to FIG. 2, but it is contemplated that preforms 50 could be produced by another type of molding machine in other non-limiting embodiments in accordance with the present technology. It is also contemplated that different types of molded articles could be produced by molding machines according to non-limiting embodiments of the present technology, including but not limited to: closures, thin-wall containers, medical appliances, and the like.

In the embodiment described herewith, the preform 50 is a multilayer preform. It is to be noted that this is a non-limiting embodiment of the molded article, as it is contemplated that in other embodiments, the preform 50 could be a monolayer preform. The multilayer preform 50 includes a neck portion 32, a gate portion 36 and a body portion 34 extending between the neck portion 32 and the gate portion 36. The gate portion 36 is associated with a substantially spherical shape that terminates in a vestige portion 38.

The multilayer preform 50 is formed by at least two layers. On exterior sides, the multilayer preform 50 has a skin layer 20. The skin layer 20 can be made of various materials. For example, in multilayer preforms 50 for making beverage containers, the skin layer 20 is made of virgin polyethylene terephthalate (PET), which is approved by the FDA for use in contact with foodstuffs. It is contemplated that the skin layer 20 could be made of various other materials, including any appropriate polymer resins and thermoplastics, as will be appreciated by those skilled in the art. Though not depicted herein, it is contemplated that in some embodiments, the multilayer preform 50 could have a cavity identification number imprinted in the skin layer. The cavity identification number could be located in the neck portion 32, in the body portion 34 and/or in the gate portion 34. As will be described below, each cavity 118 of one or more mold cavities 118 of the injection molding machine 100 has a cavity origin insert which imprints the cavity identification number 25 of each cavity 118, each cavity identification number being unique to each cavity 118.

The skin layer 20 surrounds a core layer 40, the core layer 40 being generally made of a different material, or a different state of the same material, than the skin layer 20. At a top end of the preform 50, the core layer 40 begins at a leading edge 42. At a bottom end of the preform 50, the core layer 40 terminates at a trailing edge 44. In some embodiments, the core layer 40 is used to impart different properties to the preforms 50, such as increased rigidity. The core layer 40, in some embodiments, can act as a barrier layer in the eventual blow-molded container blown from the preform 50. In such cases, the barrier layer can help to prevent transmission of, for example, oxygen or light into an interior of the blow-molded container. The core layer 40 can also be made from any one of various appropriate thermoplastics and polymer resins as will be appreciated by those skilled in the art. It is contemplated that the core layer 40 could be also contain various additives, coloring, or property adjusting agents to affect different properties of the multilayer preform 50.

With reference to FIG. 2, there is depicted a non-limiting embodiment of the injection molding machine 100 which can be adapted to implement embodiments of the present technology. For illustration purposes only, it shall be assumed that the injection molding machine 100 makes the multilayer preforms 50 described above that are subsequently processed by a molding system 200 according to an embodiment of the present technology. It should be understood that in alternative non-limiting embodiments, the injection molding machine 100 may include other types of molding systems, such as, but not limited to, compression molding systems, compression injection molding systems, transfer molding systems, metal molding systems and the like.

In the non-limiting embodiment of FIG. 2, the molding machine 100 includes a stationary platen 102 and a movable platen 104. The stationary platen 102 is also referred to as a stationary platen 102. In some embodiments of the present technology, the molding machine 100 may include a third non-movable platen (not depicted). Alternatively or additionally, the molding machine 100 may include turret blocks, rotating cubes, turning tables and the like (all not depicted but known to those of skill in the art).

The injection molding machine 100 further includes an injection unit 106 for plasticizing and injection of the molding material. The injection unit 106 can be implemented as a single stage or a two-stage injection unit.

Operatively connected to the injection unit 106, the injection molding machine 100 further includes a additive device 107 that is configured to dispense an additive into the injection unit 106 to change a color of resin present within the injection unit 106. As a result of a change in the color the resin (i.e., as a result of adding the additive into the injection unit 106), the color of the multilayer preforms 50 being produced will also change. In the present embodiment, the additive device 107 is a color doser 107, and the additive is a colorant. It is contemplated that in some embodiments the color doser 107 could be configured to add two or more colorants into the injection unit 106. Additionally, although only one color doser is depicted in the accompanying figures, it is contemplated that in other embodiments the injection molding machine 100 could have two or more color dosers. For example, in one embodiment, one color doser could be configured to address yellow tints that may be present in the molded articles 50 by dispensing blue colorant, whereas the another color doser could be configured to address green tints that may be present in the molding articles 50 by dispensing red colorant. Furthermore, it is contemplated that the additive device 107 could be configured to add various substances besides colorant into the injection unit 106. For example, in some embodiments, the additive device 107 could be configured to add an anti-oxidant to reduce yellowness of the molded articles 50.

In operation, the movable platen 104 is moved towards and away from the stationary platen 102 by means of stroke cylinders (not shown) or any other suitable means. Clamp force (also referred to as closure or mold closure tonnage) can be developed within the molding machine 100, for example, by using tie bars 108, 110 (typically, four tie bars 108, 110 are present in the molding machine 100) and a tie-bar clamping mechanism 112, as well as (typically) an associated hydraulic system (not depicted) that is usually associated with the tie-bar clamping mechanism 112. It will be appreciated that clamp tonnage can be generated using alternative means, such as, for example, using a column-based clamping mechanism, a toggle-clamp arrangement (not depicted) or the like.

The molding machine 100 has a mold 113 having a first mold half 114, and a second mold half 116. The first mold half 114 can be associated with the stationary platen 102 and the second mold half 116 can be associated with the movable platen 104. In the non-limiting embodiment of FIG. 2, the first mold half 114 defines the mold cavities 118. The mold cavities 118 generally form an array, such that there is a given number of columns and a given number or rows. In some embodiments, there could be eight columns and twelve rows of mold cavities 118 making 96 cavities in total, but it should be noted that embodiments of the present technology are not limited to any specific cavitation number. As will be appreciated by those of skill in the art, the mold cavities 118 may be formed by using suitable mold inserts (such as a cavity insert, a gate insert and the like) or any other suitable means. As such, the first mold half 114 can be generally thought of as a “mold cavity half”.

The second mold half 116 includes mold cores 120 complementary to the mold cavities 118, such that the mold cores 120 also generally form an array similar to the array formed by the mold cavities 118, where the array formed by the mold cores 120 has the same number of columns and rows as the array formed by the mold cavities 118. As will be appreciated by those of skill in the art, the mold cores 120 may be formed by using suitable mold inserts or any other suitable means. As such, the second mold half 116 can be generally thought of as a “mold core half”. Even though not depicted in FIG. 2, the first mold half 114 may be further associated with a melt distribution network, commonly known as a hot runner, for distributing molding material from the injection unit 106 to each of the mold cavities 118. Also, the second mold half 116 is provided with neck rings (not depicted) produce preforms with the neck portions 32.

The first mold half 114 can be coupled to the stationary platen 102 by any suitable means, such as a suitable fastener (not depicted) or the like. The second mold half 116 can be coupled to the movable platen 104 by any suitable means, such as a suitable fastener (not depicted) or the like. It should be understood that in an alternative non-limiting embodiment of the present technology, the position of the first mold half 114 and the second mold half 116 can be reversed and, as such, the first mold half 114 can be associated with the movable platen 104 and the second mold half 116 can be associated with the stationary platen 102. In an alternative non-limiting embodiment of the present technology, the stationary platen 102 need not be stationary and may be movable in relation to other components of the molding machine 100.

FIG. 2 depicts the first mold half 114 and the second mold half 116 in a so-called “mold open position” where the movable platen 104 is positioned generally away from the stationary platen 102 and, accordingly, the first mold half 114 is positioned generally away from the second mold half 116. For example, in the mold open position, a molded article (not depicted) can be removed from the first mold half 114 and/or the second mold half 116. In a so-called “mold closed position” (not depicted), the first mold half 114 and the second mold half 116 are urged together (by means of movement of the movable platen 104 towards the stationary platen 102) and cooperate to define (at least in part) molding cavities into which the molten plastic (or other suitable molding material) can be injected, as is known to those of skill in the art. Due to the arrangement of the mold cavities 118 and the mold cores 120, the molding cavities generally form an array, henceforth referred to as molding cavity array. The molding cavity array has the same number of columns and rows as the array formed by the mold cavities 118 and the mold cores 120.

It should be appreciated that one of the first mold half 114 and the second mold half 116 can be associated with a number of additional mold elements, such as for example, one or more leader pins (not depicted) and one or more leader bushings (not depicted), the one or more leader pins cooperating with one more leader bushings to assist in alignment of the first mold half 114 with the second mold half 116 in the mold closed position, as is known to those of skill in the art.

The injection molding machine 100 can further include a robot 122, sometimes referred to as a retrieval device and/or a removal device, operatively coupled to the stationary platen 102. Those skilled in the art will readily appreciate how the robot 122 can be operatively coupled to the stationary platen 102 and, as such, it will not be described in detail herein. The robot 122 includes a mounting structure 124, an actuating arm 126 coupled to the mounting structure 124 and a take-off plate 128 coupled to the actuating arm 126. The take-off plate 128 includes a plurality of molded article receptacles 130.

Generally speaking, the purpose of the plurality of molded article receptacles 130 is to remove molded articles 50 from the one or more mold cores 120 (or the one or more mold cavities 118) and/or to implement post mold cooling of the molded articles. In the non-limiting example illustrated herein, the plurality of molded article receptacles 130 includes a plurality of cooling tubes for receiving a plurality of molded preforms. However, it should be expressly understood that the plurality of molded article receptacles 130 may have other configurations. The exact number of the plurality of molded article receptacles 130 is not particularly limited. In some instances, the number of molded article receptacle 130 corresponds to the number of mold cavities 118.

Schematically depicted in FIG. 2 is the robot 122 of a side-entry type. However, it should be understood that in alternative non-limiting embodiments of the present technology, the robot 122 can be of a top-entry type. It should also be expressly understood that the term “robot” is meant to encompass structures that perform a single operation, as well as structures that perform multiple operations. In at least some embodiments, it is also contemplated that the robot 122 could be omitted and/or replaced with a differently implemented device for moving the molded articles 50.

It is to be noted that the robot 122 is configured to manipulate the molded articles 50 while preserving the molding cavity array (i.e., the robot 122 does not scramble the positioning of the molded articles).

The molding machine 100 further includes a post-mold treatment device 132 operatively coupled to the movable platen 104. Those skilled in the art will readily appreciate how the post-mold treatment device 132 can be operatively coupled to the movable platen 104 and, as such, it will not be described here in any detail. The post-mold treatment device 132 includes a mounting structure 134 used for coupling the post-mold treatment device 132 to the movable platen 104. The post-mold treatment device 132 further includes a plenum 129 coupled to the mounting structure 134. Coupled to the plenum 129 is a plurality of treatment pins 133. The number of treatment pins within the plurality of treatment pins 133 generally corresponds to the number of receptacles within the plurality of molded article receptacles 130. In at least some embodiments, it is also contemplated that the post-mold treatment device 132 could be omitted and/or replaced with a differently implemented device for treating the molded articles 50.

The molding machine 100 further includes a computing apparatus 140, also referred to herein as a processor 140, configured to control one or more operations of the molding machine 100. As will be described below, the processor 140 is further configured to control one or more operations of the molding system 200 that the molding machine 100 is part of, and which will be described in greater detail below. As will be appreciated by those skilled in the art, the computing apparatus 140 may include a plurality of processors or computer-implemented devices operatively connected together.

The processor 140 includes a human-machine interface (not separately numbered) or an HMI, for short. The HMI of the processor 140 can be implemented in any suitable interface. As an example, the HMI of the processor 140 can be implemented in a multi-functional touch screen. An example of the HMI that can be used for implementing non-limiting embodiments of the present technology is disclosed in co-owned U.S. Pat. No. 6,684,264, content of which is incorporated herein by reference, in its entirety.

Those skilled in the art will appreciate that the processor 140 may be implemented using pre-programmed hardware or firmware elements (e.g., application specific integrated circuits (ASICs), electrically erasable programmable read-only memories (EEPROMs), etc.), or other related components. In other embodiments, the functionality of the processor 140 may be achieved using a processor that has access to a code memory (not shown) which stores computer-readable program code for operation of the computing apparatus, in which case the computer-readable program code could be stored on a medium which is fixed, tangible and readable directly by the various network entities, (e.g., removable diskette, CD-ROM, ROM, fixed disk, USB drive), or the computer-readable program code could be stored remotely but transmittable to the processor 140 via a modem or other interface device (e.g., a communications adapter) connected to a network (including, without limitation, the Internet) over a transmission medium, which may be either a non-wireless medium (e.g., optical or analog communications lines) or a wireless medium (e.g., microwave, infrared or other transmission schemes) or a combination thereof.

In alternative non-limiting embodiments of the present technology, the HMI does not have to be physically attached to the processor 140. As a matter of fact, the HMI for the processor 140 can be implemented as a separate device. In some embodiments, the HMI can be implemented as a wireless communication device (such as a smartphone, for example) that is “paired” or otherwise communicatively coupled to the processor 140.

The processor 140 can perform several functions including, but not limited to, receiving from an operator control instructions, controlling the molding machine 100 based on the operator control instructions or a pre-set control sequence stored within the processor 140 or elsewhere within the molding machine 100, acquire one or more operational parameters associated with the molding system and the like. According to non-limiting embodiments of the present technology, the processor 140 is further configured to process one or more of the acquired operational parameters associated with the molding system 200 and output information to the operator using the HMI and the like.

The molding machine 100 further includes a number of monitoring devices (not depicted), the monitoring devices being configured to acquire various operational parameters associated with the performance of the molding machine 100. Generally speaking, these monitoring devices are known in the art and, as such, will not be described here at any length.

Just as an example, the injection molding machine 100 may include a counter to count mold opening and closing to determine the number of cycles over a period of time and/or the cycle time of each cycle. The injection molding machine 100 may also include a number of pressure gauges to measure pressure within various components of the injection molding machine 100 (such as hydraulic fluid pressure or molding material pressure).

According to non-limiting embodiments of the present technology, the processor 140 is configured to acquire a plurality of operational parameters associated with the molding machine 100. The nature of the so-acquired plurality of operational parameters can vary. How the processor 140 acquires the plurality of operational parameters will depend, of course, on the nature of the so-acquired plurality of operational parameters.

The processor 140 can acquire machine variables by monitoring the operation of the molding machine 100. Just as an example, the processor 140 can acquire the cycle time by monitoring the performance of the molding machine 100. Naturally, the processor 140 can acquire some of the machine variables by either the operator entering them using the HMI or by reading a memory tag (not depicted) associated with the mold (i.e. the above described first mold half 114 and the second mold half 116) that is used in the molding machine 100. Various implementations of the memory tag (not depicted) are known in the art. Generally speaking, the memory tag (not depicted) may store information about the mold, the molded article to be produced, pre-defined control sequences, set-up sequences and the like.

For example, the operator may enter an indication of cavitation of the injection molding machine 100 using the HMI of the processor 140 (in which case, the cavitation can be considered to be an operational and supervisory variable). Alternatively, the mold (i.e. the above described first mold half 114 and the second mold half 116) may be equipped with the memory tag, which memory tag may for example store an indication of the cavitation of the mold. In those implementations, the processor 140 can acquire the cavitation by accessing the memory tag and reading the information therefrom (in which case, the cavitation can be considered to be a machine variable). In yet further embodiments, the memory tag may contain an indication of the mold cavitation of the mold (i.e. the above described first mold half 114 and the second mold half 116), but some of the mold cavities may not be operational at the time. Within those examples, the operator or the supervisor could enter the actual cavitation using the HMI (in which case, the cavitation could again be considered to be an operational and supervisory variable).

In some non-limiting embodiments of the present technology, the processor 140 can acquire the operational and supervisory variables by receiving an indication of those parameters from the operator. However, within some implementations of the molding machine 100, it is possible for the processor 140 to acquire some (or even all) of the operational and supervisory variables by monitoring performance of the molding machine 100. For example, some implementations of the molding machine 100 may include a device for weighing molded articles and/or a device to keep track of scrapped molded articles (for example, those molded articles that do not quality or weight specifications). Within those embodiments, the processor 140 can acquire the part weight and/or scrap rates by monitoring the performance of the molding machine 100. Naturally, other ways for the processor 140 to acquire some or all of these or other operational parameters are possible, some of which will be described below.

Still referring to FIG. 2, there is depicted a non-limiting embodiment of the molding system 200 which can be adapted to implement embodiments of the present technology. The molding system 200 includes the injection molding machine 100 for making molded articles, in this described instance, the preforms 50, as well as a vision system 250. In some instances, the molding system 200 could further include a processor distinct from the processor 140. In the present embodiment, however, the processor 140 is associated to both the injection molding machine and the molding system 200. In some additional embodiments of the present technology, the processor can be associated with a plant where the injection molding machine 100 is located and the processor 140 can be configured to control multiple systems, including the molding system 200. The molding system 200 is illustrated, and, as such, described with respect to the embodiment of the injection molding machine 100 described hereabove.

It is contemplated that different embodiments of the injection molding machine 100 could be included in the molding system 200. It is also contemplated that the molding system 200 could further include different molding equipment, such as but not limited to: a compression molding machine, injection compression molding machine, extrusion blow molding machine, transfer molding machine and the like.

As mentioned above, the molding system 200 includes the vision system 250. The vision system 250 includes a detector 252 and a light source 254.

The detector 252, which is sometimes referred to as an optical device and/or inspection device, is configured to detect a color of the preforms 50. In the present embodiment, the detector 252 is a camera. It is contemplated that in other embodiments, the detector 252 could be a color sensor instead of a camera. Additionally, although only one detector 252 is depicted in the accompanying figures, it is contemplated that the vision system 250 could include two or more detectors. The detector 252 is connected to injection molding machine 100. More precisely, the detector 252 is connected to the plenum 129 via a connecting structure 253. In some embodiments, the connecting structure 253 could be operable to adjust a vertical and/or horizontal position of the detector 252. It is understood that the detector 252 could be connected elsewhere. For example, in some instances, the detector 252 could be connected to the actuating arm 126 of the robot 122. In other instances, the detector 252 could be separate from the injection molding machine 100. As is illustrated schematically in FIG. 2, the detector 252 and the processor 140 are operatively coupled to one another. As such, the detector 252 can communicate data generated thereby with the processor 140, and can be controlled by the processor 140. More precisely, the detector 252 can communicate the detected color of the preforms 50 to the processor 140. In some instances, the detector 252 can communicate the detected color as a set of three color parameters such as a Red Green Blue values (RGB model), Hue Saturation Lightness values (HSL model) or L*a*b* values (CIELAB color space model). As will be described below, the detector 252 can transmit data to the processor 140 to adjust operation of the color doser 107.

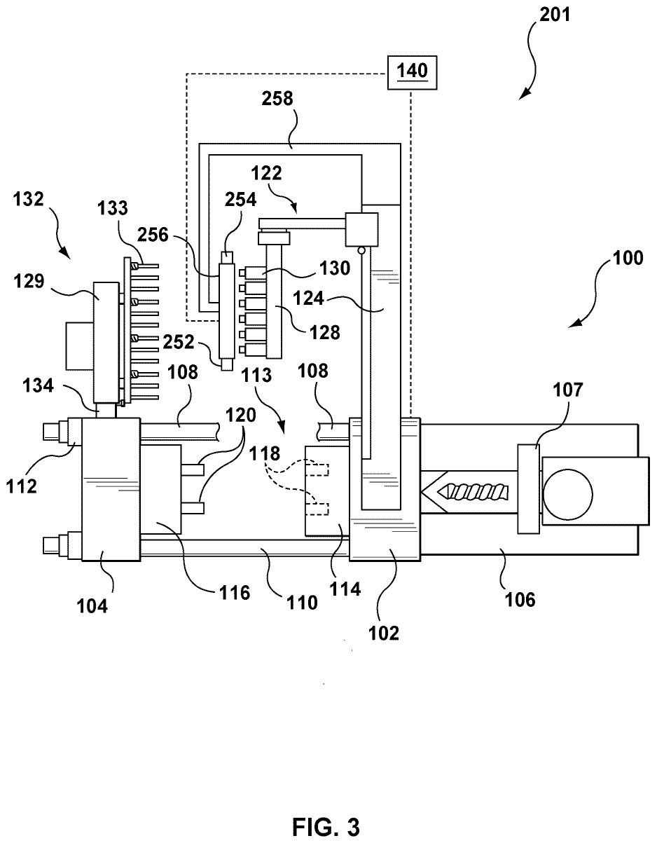

The light source 254 is connected to the detector 252. In other embodiments, such as ones shown in FIGS. 3, 4A, 4B, 5A, 5B, the light source 254 could be disposed generally opposite to the light source 254 (i.e. the light source 254 could be disconnected from the detector 252). In some instances, the light source 254 could be connected to another component. For example, the light source 254 could be connected to the robot 122. The light source 254 is for illuminating the multilayer preforms 50, which can assist the detector 252 in detecting the color of the multilayer preforms 50. In some embodiments, the light source could be a multispectral light source. In some embodiments, the light source 254 could be omitted.

With continued reference to FIG. 2, the molding system 200 in operation will now be described. As briefly described hereabove, the molding machine 100 molds a plurality of preforms 50. The plurality of preforms 50 are removed from the mold cores 120 by the robot 122.

Then, the robot 122 manipulates the preforms 50 to place at least some of the preforms 50 in a field of vision of the detector 252. It is contemplated that in some embodiments, only two preforms 50 could be placed in the field of vision of the detector 252. In other embodiments, three or more preforms 50 (but not all) could be placed in the field of vision (depicted by dotted lines in FIG. 2) of the detector 252. Furthermore, in certain embodiments, the robot 122 could slowly move the preforms 50 along the field of vision of the detector 252 (i.e., one preform at a time, one row of preform at a time, or a column of preform at a time), whereas in other embodiments, the robot 122 could place, at once, all of the preforms 50 of which the colors are to be detected, in the field of vision of the detector 252.

The detector 252 detects the color of each of the preforms 50 passing through its field of vision. As mentioned above, in some embodiments of the molding system 200, the detector 252 could only be configured to only detect the color of some of the preforms 50. The detector 252 transmits data generated thereby to the processor 140. As mentioned above, the transmitted data can be provided as a set of three parameters.

The processor 140 analyzes the data provided by the detector 252. The processor 140 sorts through the data to distinguish workable data from unworkable data. Indeed, in some instances, for a variety of reasons, such as notably, inadequate lighting conditions, the color detected by the detector 252 of one or more of the preforms 50 may not be useable (i.e., outlier values). With the workable data, the processor 140 calculates an average of the detected color of the preforms 50 that went through the field of vision of the detector 252, and for which the data was useable. This average is referred to as average detected color.

It is contemplated that the processor 140 could calculate the average detected color based in a variety of ways. For example, in some embodiments, the processor 140 could calculate the average detected color based on the data generated by the detector 252 over a plurality of molding cycles. In other embodiments, the processor 140 could calculate the average detected color based on data from preforms 50 from a given molding cavity across one or a plurality of molding cycles. In yet other embodiments, the processor 140 could calculate the average detected color based on data from various preforms originating from different molding cavities of the mold 113. Other such combinations are contemplated.

The processor 140 then compares the average detected color with the desired color of the preforms 50. In response to a difference therebetween being different from a predetermined value, the processor 140 controls the color doser 107 to correct the difference (i.e., for correcting the detected color of the preforms formed in the following molding cycles). It is to be noted that the predetermined value can be pre-set by the operator and/or can be adjusted as desired during the manufacturing process.

In an embodiment where the detected color is transmitted to the processor 140 under the RGB model, there is a predetermined value for each one of the RGB parameters. In one non-limiting example, the predetermined value for each of the red, green and blue color values is three. In another non-limiting example, the predetermined value for the red color value is two, the predetermined value for the green color value is three, and the predetermined value for the blue color value is five. Thus, the predetermined value could be the same for each of the RGB parameters, or could differ from one parameter to another.

As mentioned above, in response to the difference between the average detected color and the desired color being different from the predetermined value, the processor 140 controls the color doser 107 in such a manner as to reduce the difference between average detected and desired colors (i.e., such that the color of the preforms 50 more closely resembles the desired color). To this end, the color doser 107 can add one of the colorants into the injection unit 106, and/or can stop the addition of one of the colorants into the injection unit 106.

Where there is a need for the color doser 107 to add one or more colorant into the injection unit 106, the processor 140 could be configured to control the color doser 107 according to a pre-calculated remedial model that follows a first-order system such as first order plus time delay (FOPTD)/first order plus dead time (FOPDT). This can reduce likelihood of overshooting the amount of the colorant that needs to be added, and can thus reduce waste generation, not only by reducing the amount of defective products, but also by reducing the amount of colorant used. In another aspect, use of the pre-calculated remedial model can assist in avoiding oscillation in detected color. Tuning parameters of the pre-calculated remedial model can include a gain value, a time delay value and a time constant value, which can be determined by performing a test, usually before initiating the manufacturing of the preforms 50. It is to be noted that the tuning parameters generally do not change, unless the desired color and/or the resin consistency is changed. It is understood that the color doser 107 could be operable to add colorant differently, for example, without following a first-order system.

Upon adding the color doser 107, the detector 252 can continue to detect the color of the preforms 50 formed in the subsequent molding cycles, but it is to be noted that a time delay between the addition of at least one colorant by the color doser 107 and the production of preforms 50 with correct color is expected.

After waiting for a number of molding cycles corresponding to the time delay (i.e., time response for the effects of the color doser 107 to be in full effect), the robot 122, the detector 252 and the processor 140 repeat the steps described hereabove until the average detected color is sufficiently close to the desired color.

It is to be noted that the present technology enables to evaluation of the color of the preforms 50 as a whole rather than individually, which can, in some instances be beneficial to get a broader sense of the color of the preforms 50.

Though not depicted herewith, it is contemplated that in some embodiments, the robot 122 could release the preforms 50 onto a device such as a conveyer belt, and once placed thereon, the detector 252 could detect the color of the preforms 50.

In an alternative embodiment of the molding system 200, namely molding system 201, shown in FIG. 3, the vision system 250 includes, in addition to the detector 252 and the light source 254, a black box enclosure 256. As will be elaborated below, the black box enclosure 256 is configured to receive preforms therein to assist the detector 252 in detecting the color of the preforms 50. In this embodiment, like in the molding system 200, the color of at least some of the preforms 50 is detected, such that the black box enclosure 256 is configured to receive an associated number of the preforms 50.

In the embodiment illustrated in FIG. 3, the black box enclosure 256 is connected to the mounting structure 124 of the robot 122 by a connecting structure 258. It is contemplated that in some embodiments, the connecting structure 258 could be moveable to adjust a position of the black box enclosure 256 relative to the molded article receptacles 130 (i.e., relative to the robot 122). In other embodiments, the black box enclosure 256 could be connected elsewhere. For example, in some embodiments, the black box enclosure 256 could be connected to the plenum 129.

The detector 252 is disposed at one end of the black box enclosure 256, and the light source 254 is disposed at the other end of the black box enclosure 256. Being opposite to one another can assist in providing optimal lighting for the detector 252 to effectively detecting the color of the preforms 50 received in the black box enclosure 256. In some embodiments, there could be two or more detectors 252, and/or two or more light sources 254.

In this embodiment, the robot 122 is configured to guide the preforms 50 into the black box enclosure 256. Once received in the black box enclosure 256, the only light source illuminating the preforms 50 is the light source 254. As a result, when the detector 252 detects the color of the preforms 50, the lighting conditions for all the preforms 50 are generally similar. This can assist the detector 252 in providing more consistent readings. After the detector 252 detects the color of the preforms 50, the robot 122 removes the preforms 50 from the black box enclosure 256. The robot 122 can then drop them onto a receiving device such as a bin or a conveyer belt.

In some embodiments, the overall operation of the detector 252, the processor 140 and the color doser 107 of the molding system 201 is similar to what was described hereabove with reference to the molding system 200, and hence will not be described in detail herewith.

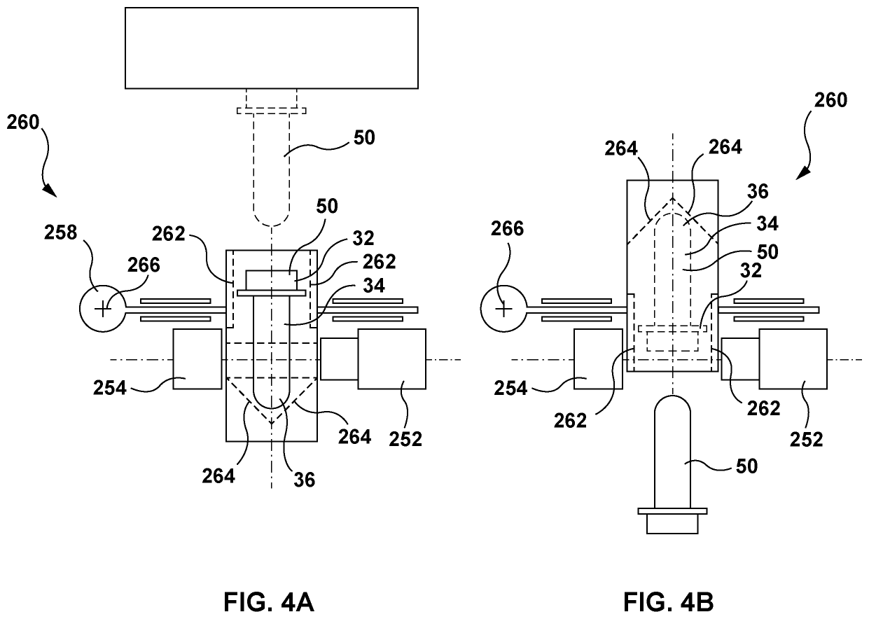

With reference to FIGS. 4A and 4B, an alternative embodiment of the black box enclosure 256, namely black box enclosure 260, will now be described. Like the black box enclosure 256, the black box enclosure 260 is connected to the mounting structure 124 via the connecting structure 258. The black box enclosure 260 is adjustable between a receiving position (depicted in FIG. 4A), in which the black box enclosure 260 is configured to receive the preforms 50, and a releasing position (depicted in FIG. 4B), in which the black box enclosure 260 is configured to release the preforms 50. Though only one preform 50 is shown in FIGS. 4A and 4B, it is contemplated that the black box enclosure 260 could be configured to receive two or more preforms 50.

The black box enclosure 260, which is configured to receive the preforms 50, has an open ended upper end, and a closed ended bottom end. To hold the preforms 50 received therein in a stable position, the black box enclosure 260 has upper supporting walls 262 that are sized to closely surround outermost radial ends of the neck portion 32 of the preforms 50. Furthermore, the black box enclosure 260 also has lower supporting walls 264 that are angled relative to one another, and sized to receive the gate portion 36. As such, when the preforms 50 are received in the black box enclosure 260, the preforms 50 are generally kept stable in an upright position. It is contemplated that in other embodiments, the black box enclosure 260 could be configured to maintain the preforms 50 stable in another position (e.g., lying flat). The black box enclosure 260 defines apertures which provide the detector 252 and the light source 254 optical access to the inside of the black box enclosure 260 (i.e., enabling the light source 254 to shine light within the black box enclosure 260, and enabling the detector 252 to detect the color of the preforms 50).

In the present embodiment, when the black box enclosure 260 is in the receiving position, the black box enclosure 260 is positioned vertically below the robot 122, such that the robot 122 can simply release the preforms 50 into the black box enclosure 260 through the open end thereof.

After the detector 252 detects the color of the preforms 50, the black box enclosure 260 is adjusted to the releasing position. To do so, the connecting structure 258 is configured to rotate the black box enclosure 260 about an axis 266, from the receiving position to the releasing position. Since the upper end of the black box enclosure 260 is open ended, the preforms 50 fall out of the black box enclosure 260 when in the releasing position. The black box enclosure 260 could be placed above a bin configured to receive preforms, or over a conveyer belt. It is to be noted that in this embodiment, upon rotation of the black box enclosure 260 about the axis 266, the detector 252 and the light source 254 do not rotate about the axis 266 (i.e., the detector 252 and the light source 254 are not fixedly connected to the black box enclosure 260). Lives of the detector 252 and the light source 254 can be extended by reducing movement thereof. The detector 252 and the light source 254 can be connected to the connecting structure 258 or could be connected elsewhere.

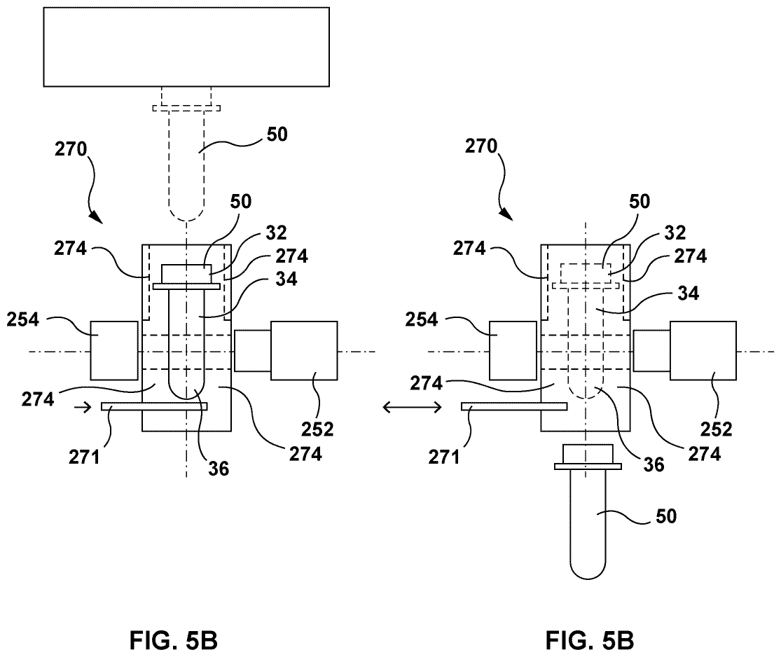

With reference to FIGS. 5A and 5B, an alternative embodiment of the black box enclosure 256, namely black box enclosure 270, will now be described. Like the black box enclosures 256, 260, the black box enclosure 270 is connected to the mounting structure 124 via the connecting structure (not depicted in FIGS. 5A and 5B). Broadly, the black box enclosure 270 has a moveable member 271. The moveable member 271 is, in the present embodiment, a sliding member 271 that is moveable between a receiving position (depicted in FIG. 5A), in which the black box enclosure 260 is also in a receiving position, and is configured to receive preforms 50, and a releasing position (depicted in FIG. 5B), in which the black box enclosure 270 is also in a releasing position, and is configured to release preforms 50. As mentioned above, although only one preform 50 is shown in FIGS. 5A and 5B, it is contemplated that the black box enclosure 270 could be configured to receive two or more preforms 50. The black box enclosure 270, which is configured to receive the preforms 50, has an open ended upper end and an open ended bottom end. To hold the preforms 50 received therein in a stable position, the black box enclosure 270 has upper supporting walls 272 that are sized to closely surround outermost radial ends of the neck portion 32 of the preforms 50. As such, when the preforms 50 are received in the black box enclosure 270, the preforms 50 are generally kept stable in an upright position. It is contemplated that in other embodiments, the black box enclosure 270 could be configured to maintain the preforms 50 stable in another position (e.g., lying flat). The black box enclosure 270 defines apertures which provide the detector 252 and the light source 254 optical access to the inside of the black box enclosure 270 (i.e., enabling the light source 254 to shine light within the black box enclosure 270, and enabling the detector 252 to detect the color of the preforms 50).

The black box enclosure 270 further defines an aperture configured to receive the sliding member 271. As mentioned above, the sliding member 271 is moveable between the receiving and releasing positions. It is contemplated that in other embodiments, the sliding member 271 could be a pivotable member pivoting between the receiving and releasing positions.

In the present embodiment, when the black box enclosure 270 is set to receive the preforms 50 therein (i.e., the sliding member 271 is in the receiving position), the black box enclosure 270 is positioned vertically below the robot 122, such that the robot 122 can simply release the preforms 50 into the black box enclosure 270 through the open end thereof.

After the detector 252 detects the color of the preforms 50, the sliding member 271 moves to the releasing position. As the preforms 50 are no longer supported, they fall out of the black box enclosure 270.

The black box enclosure 270 could be placed above a bin configured to receive preforms, or over a conveyer belt.

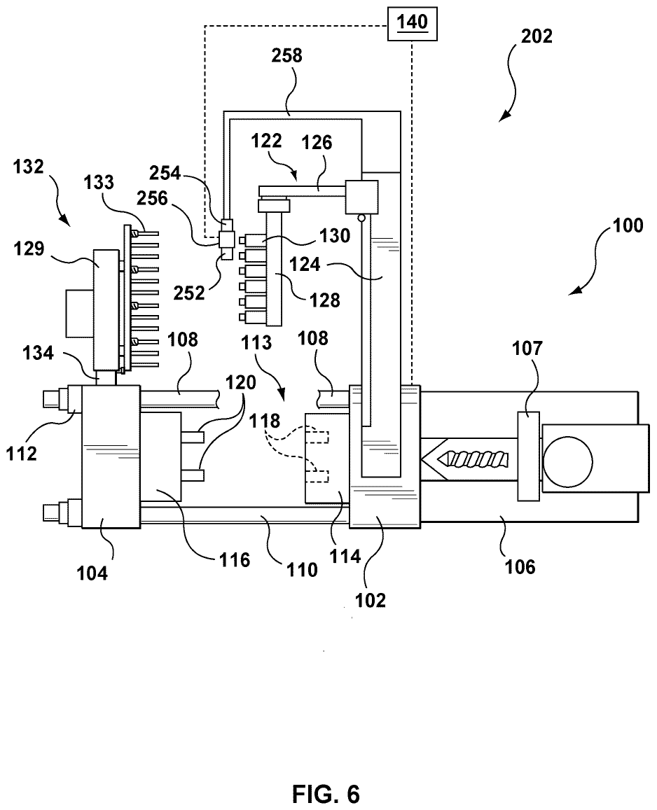

With reference to FIG. 6, an alternative embodiment of molding system 201, namely molding system 202, will now be described. Features of the molding system 202 similar to those of the molding system 201 have been labeled with the same reference numerals, and will not be described in detail herewith again.

One notable difference between the molding systems 201, 202, is that the black box enclosure 256 of the molding system 202 is configured to receive a single preform 50 therein. It is contemplated that in some embodiments, the black box enclosure 256 of the molding system 202 could be similar to the black box enclosures 260, 270 described hereabove.

Thus, in operation, only one of the preforms 50 is received in the black box enclosure 256. The detector 252 detects the color of the one of the preforms 50, and in response to the processor 140 determining that the detected color is different from a desired color by a predetermined amount, the processor 140 controls the color doser 107 to add a colorant in the injection unit 106. It is contemplated that in some embodiments, the detector 252 could detect the color of one of the preforms 50 over a plurality of molding cycles, and then the processor 140 could calculate the average of the detected color over the plurality of molding cycles, and control the color doser 107 accordingly. In this embodiment, the preform 50 of which the color is detected is always from the same mold cavity. In other embodiments, the black box enclosure 256 and/or the robot 122 could be moveable relative to one another so that preforms from different mold cavities are analyzed. In yet other embodiments, the molding system 202 could have two or more black box enclosure analyzing two or more preforms 50. The processor 140 could calculate an average of the color detected in each of the two or more black box enclosures 256 and control the color doser 107 accordingly.

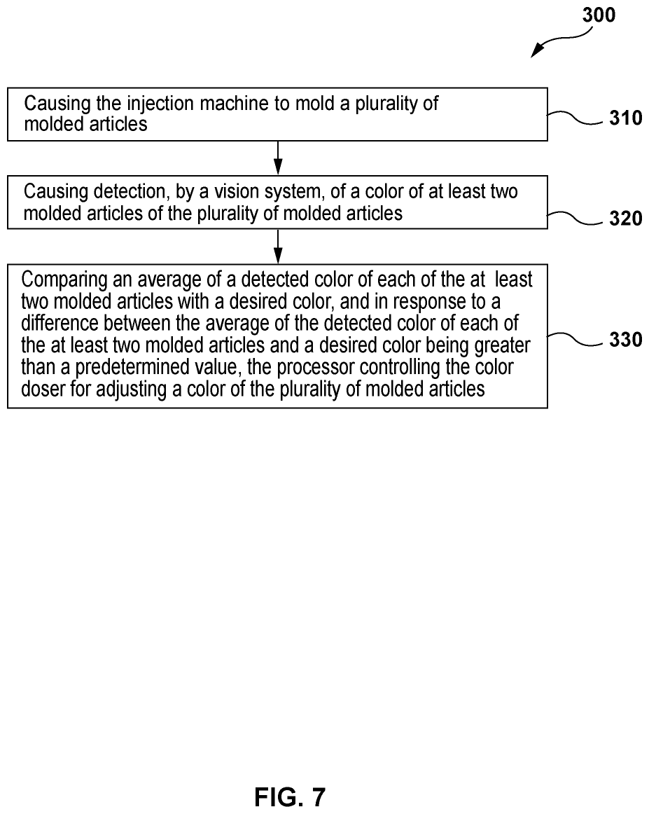

With reference to FIG. 7, illustrated by a block diagram, a method 300, which is executable by the processor 140, and which is in accordance with non-limiting embodiments of the present technology, will now be described. The method 300 will be described herein with respect to the molding system 200 described hereabove, but it is contemplated that the method could apply to the molding system 201, as well as other non-limiting embodiments of a molding system according to the present technology.

### Step 310—Causing a Mold of the Injection Molding Machine to Mold a Plurality of Molded Articles

The method 300 begins, at step 310, with causing the mold 113 of the injection molding machine 100 to mold a plurality of molded articles, namely the preforms 50. The mold 113, as mentioned above defines the plurality of molding cavities, which forms the molding cavity array having a given number or columns and rows.

### Step 320—Causing Detection of a Color of at Least Two Molded Articles of the Plurality of Molded Articles

The method then continues, at step 320, causing detection, by the detector 252 of the vision system 250, of a color of the at least two preforms 50 of the plurality of preforms 50.

In some embodiments, the method includes detecting the color over a plurality of molding cycles.

In some embodiments, the detector 252 detects the color of the at least two preforms 50 once the at least two preforms 50 are received in the black box enclosure 256.

According to another aspect of the present technology, the method could continue by causing detection of a single preform 50 of the plurality of preforms 50.

### Step 330—Comparing an Average of a Detected Color of Each of the at Least Two Molded Articles

The method then continues, at step 330, comparing an average of the detected color of each of the at least two preforms 50 with the desired color. In response to the difference therebetween being different from the predetermined value, the processor 140 controls the color doser 107 to adjust the color of the plurality of preforms 50 manufactured in the following molding cycles.

In some embodiments of the method, the processor 140 is configured to control the color doser 107 according to the pre-calculated remedial model.

In some embodiments of the method, the method further includes running a testing cycle to determine the tuning parameters of the pre-calculated remedial model.

In some embodiments where color detection occurs over the plurality of molding cycles, the average of the detected color of the at least two molded articles is determined over the plurality of molding cycles.

In some embodiments, the method 300 terminates and/or returns to step 310.

In some embodiments, the method 400 terminates and/or returns to step 410.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

The description of the embodiments of the present technology provides only examples of the present technology, and these examples do not limit the scope of the present technology. It is to be expressly understood that the scope of the present technology is limited by the claims only. The concepts described above may be adapted for specific conditions and/or functions and may be further extended to a variety of other applications that are within the scope of the present technology. Having thus described the embodiments of the present technology, it will be apparent that modifications and enhancements are possible without departing from the concepts as described.

1. A molding system (200, 201, 202) comprising:
a molding machine (100) for producing a plurality of molded articles 50, the molding machine (100) having an additive device (107) for adjusting a color of the plurality of molded articles (50);
a vision system (250) for detecting a color of each of at least two molded articles (50) of the plurality of molded articles (50); and
a processor (140) operatively connected to the molding machine (100) and to the vision system (250), the processor (140) being configured to analyze data generated by 10 the vision system (250), and in response to a difference between (i) an average of a detected color of at least two molded articles (50) and (ii) a desired color being different from a predetermined value, the processor (140) being configured to control the additive device (107) for adjusting the color of the plurality of molded articles (50).

2. The molding system (200, 201, 202) of claim 1, wherein in order to adjust the color of the plurality of molded articles (50), the additive device (107) is configured to add an additive into an injection unit (106) of the molding machine (100).

3. The molding system (200, 201, 202) of claim wherein the processor (140) is configured to control the additive device (107) according to a pre-calculated remedial model.

4. (canceled)

5. (canceled)

6. The molding system (200, 201, 202) of claim 1, 5, wherein the average of the detected color of the at least two molded articles (50) is taken over a plurality of molding cycles.

7. (canceled)

8. (canceled)

9. (canceled)

10. (canceled)

11. The molding system (200, 201, 202) of claim 1, wherein:
the at least two molded articles (50) includes all of the plurality of molded articles (50), and the processor (140) is configured to analyze the data generated by the vision system (250) to determine workable data and unworkable data, and to calculate the average of the detected color from the workable data.

12. (canceled)

13. The molding system (200, 201, 202) of claim 1, wherein the vision system (250) includes:
a black box enclosure (256, 260, 270) configured to receive the at least two molded articles (50);
a light source (254) for illuminating the at least two molded articles (50) ; and
a detector (252) configured to detect a color of the at least two molded articles (50).

14. The molding system (200, 201, 202) of claim 13, wherein the black box enclosure (260) is adjustable between a receiving position, in which the black box enclosure (260) is configured to receive a molded article (50), and a releasing position, in which the blackbox enclosure (260) is configured to release the molded article (50).

15. The molding system (200, 201, 202) of claim 13, wherein the black box enclosure (270) has moveable member (271) moveable between a receiving position, in which the black box enclosure (270) is configured to receive a molded article (50), and a releasing position, in which the black box enclosure (270) is configured to release the molded article (50).

16. The molding system (200, 201, 202) of claim 1, wherein the additive device (107) is a first additive device, and the molding machine further includes a second additive device, the first color being configured to dose a first additive, and the second additive device being configured to dose a second additive.

17. A molding system (200, 201, 202) comprising:
a molding machine (100) for producing a plurality of molded articles (50), the molding machine (100) having a additive device (107) for adjusting a color of the plurality of molded articles (50);
a vision system (250) configured to inspect at least one molded article (50) of the plurality of molded articles (50), the vision system (250) comprising:
a black box enclosure (256, 260, 270) configured to receive the at least one molded article (50);
a light source (254) for illuminating the at least one molded article (50); and
a detector (252) configured to detect a color of the at least one molded article (50);
a processor (140) operatively connected to the molding machine (100) and to the vision system (250), the processor (140) being configured to analyze data generated by the vision system (250) and in response to a detected color of the at least one molded article (50) being different from a desired color, the processor (140) controlling the additive device (107) for adjusting a color of the plurality of molded articles (107).

18. The molding system (200, 201, 202) of claim 17, wherein the black box enclosure (260) is rotatable between a receiving position, in which the black box enclosure (260) is configured to receive a molded article (50), and a release position, in which the black box enclosure (260) is configured to release the molded article (50).

19. The molding system (200, 201, 202) of claim 17, wherein the black box enclosure (270) has a moveable member (271) moveable between a receiving position, in which the black box enclosure (270) is configured to receive a molded article (50), and a release position, in which the black box enclosure (270) is configured to release the molded article (50).

20. The molding system (200, 201, 202) of claim 17, wherein in order to adjust the color of the plurality of molded articles (50), the additive device (107) is configured to add an additive into an injection unit (106) of the molding machine (100).

21. The molding system (200, 201, 202) of claim 17, wherein the processor (140) is configured to control the additive device (107) according to a precalculated remedial model.

22. (canceled)

23. The molding system (200, 201, 202) of claim 17, wherein the processor (140) is configured to take an average of the detected color of the at least one molded article (50) over a plurality of molding cycles.

24. (canceled)

25. (canceled)

26. (canceled)

27. (canceled)

28. (canceled)

29. The molding system (200, 201, 202) of claim 17, wherein the additive device (107) is a first additive device, and the molding machine (100) further includes a second additive device, the first color being configured to dose a first additive, and the second additive device being configured to dose a second additive.

30. A method (300) for optically inspecting at least two molded articles (50), the method (300) being executable by a processor (140) of an injection molding machine (100), the method (300) comprising:
causing (310) the injection machine (100) to mold a plurality of molded articles (50); causing (320) detection, by a vision system (250), of a color of at least two molded articles (50) of the plurality of molded articles (50);
comparing (330) an average of a detected color of each of the at least two molded articles (50) with a desired color, and in response to a difference between the average of the detected color of each of the at least two molded articles (50) and a desired color being different from a predetermined value, the processor (140) controlling the additive device (107) for adjusting a color of the plurality of molded articles (50).

31. The method (300) of claim 30, wherein the processor (140) is configured to control the additive device (107) according to a pre-calculated remedial model.

32. The method 5 (300) of claim 31, further comprising running a testing cycle to determine parameters of the pre-calculated remedial model.

33. The method (300) of claim 30, further comprising causing detection over a plurality of molding cycles, and the average of the detected color of each of the at least two molded articles (50) is determined over the plurality of molding cycles.
